(19) United States
(12) Patent Application Publication
(10) Pub. No.: US 2005/0103179 A1
(43) Pub. Date: May 19, 2005

(54) Multifunction punch apparatus

(76) Inventors: Makoto Mori, Tokyo (JP); Hitoshi Kawachi, Tokyo (JP); Keisuke Kawachi, Tokyo (JP)

Correspondence Address: Michael S. Leonard;Everest Intellectual Property Law Group, P.O. Box 708, Northbrook, IL, 60065, US

(21) Appl. No.: 10/990,599

(22) Filed: Nov. 17, 2004

(30) Foreign Application Priority Data
Nov. 19, 2003 (JP) 2003-388811

(51) Int. Cl. B26D 1/12; B26D 5/16

(52) U.S. Cl. 83/669; 83/628; 83/627

(57) ABSTRACT

A multifunction punch apparatus, which can arbitrarily set a sheet size and a punch hole number and punch accurate punch holes with right and left margins of a sheet balanced, wherein information as to the sheet size, a punching direction, and the punch hole number is input from a manipulation panel to a controller; a traveling of a timing belt on which a head is mounted is controlled by controlling a control motor disposed in a manipulation unit cover to determine a movement position of the head; a sheet inserted between a punch guide unit and a guide member is punched by moving a hole punch vertically through a gear and a punch drive gear by driving a spline shaft; and when lengths of the right and left margins of the sheet in which a predetermined number of holes are punched are different, the length of the left margin is corrected by manipulating increase/decrease switches to correct a position of a first punch hole from a left side of the sheet.

### BACKGROUND OF THE INVENTION

1. Field of the Invention

The present invention relates to a multifunction punch apparatus that can punch a plurality of filing holes in a sheet by moving a hole punch.

2. Description of the Related Art

A conventionally-used punch apparatus that punches a plurality of filing holes in a sheet employ a dedicated multi-hole punch in which a plurality of punches are disposed at a pitch interval corresponding to the filing hole number to be punched. Accordingly, the punch apparatus is disadvantageous in that many multi-hole punches must be prepared for different numbers of the filing holes, in order to punch the filing holes of the different numbers.

Further, since the pitches between holes to be punched are prescribed in JIS and the like, the above drawback can be at least overcome by providing a plurality of types of dedicated multi-hole punches. However, the pitches between holes prescribed in some foreign standards, for example, are different from those of JIS. In this case, punching holes based on the foreign standards cannot be performed using ordinarily-prepared hole punches.

To solve the above problems, a so-called multifunction punch apparatus has been developed which can punch a desired number of filing holes with one set of a hole punch and moreover can arbitrarily change a pitch between holes to be punched. As the multifunction punch apparatus, there have been proposed an electric punch apparatus (refer to, for example, Japanese Patent Application Laid-Open (JP-A) No. 6-55499) and a multifunction punch apparatus filed by the same applicant of the application (refer to, for example, JP-A No. 8-206996).

The electric punch apparatus disclosed in JP-A No. 6-55499 has a structure as shown in FIG. 9. That is, a sheet 62, in which holes are formed, is set on a main body 61. Further, the main body 61 is provided with a punch unit moving groove 64 along which a punch unit 63 is moved and with a punch position setting guide 65. A control hardware section 66,a not shown punch drive motor, and a not shown reflection type optical sensor which detects a guide are disposed in the punch unit 63. The control hardware section 66 is wired to the punch drive motor and the reflection type optical sensor as well as wired to a not shown moving motor for moving the punch unit 63 disposed in the main body 61 and can control the moving motor and the punch drive motor based on the position information from the reflection type optical sensor.

Further, the punch position setting guide 65, which is previously made in accordance with the punch hole number and the pitch between the holes to be punched, is set on the main body 61 in agreement with a predetermined position under the reflection type optical sensor. The sheet 62 is set with its edge in alignment with a predetermined position of the main body 61. When the reflection type optical sensor attached to the punch unit 63 detects a black mark on the punch position setting guide 65, a signal is applied to the control hardware section 66, and the moving motor is stopped in response to the signal, thereby positioning of the punch unit 63 is executed.

Thereafter, the punch drive motor disposed with in the punch unit 63 is rotated and the sheet 62 is punched with a punch blade through a punch actuation mechanism. The sheet 62 is punched each time a black mark on the punch position setting guide 65 is detected by repeating the above operation. The punching operation is finished when not shown limit switches disposed at the right and left ends of the main body 61 detect the arrival of the punch unit 63. With the above operation, holes can be punched in correspondence to the black marks formed on the punch position setting guide 65, thereby a desired number of filing holes can be punched along a side of the sheet.

The multifunction punch apparatus disclosed in JP-A No. 8-206996 has a structure shown in FIG. 10. That is, a spline shaft 72 and a screw rod 73 are disposed in parallel with each other so as to pass through a head 71 having a punch, and further a rail 74 is disposed in parallel to the screw rod 73 so that the head 71 itself is substantially supported at three points.

The head 71 is composed of side plates 76 and 77, and a guide member 78 is disposed on a side of the side plate 76.

A punch unit 79 is disposed under the guide member 78 so that a hole punch in the punch unit 79 moves vertically by being guided by the guide member 78. The hole punch is arranged such that it is moved vertically by a rotation of the spline shaft 72 through a not shown vertically-moving drive mechanism. A dog 81 is disposed in parallel with the screw rod 73 to control the movement position of the head 71.

A plurality of sets of recesses are formed on an outer peripheral surface of the dog 81 along an axial direction of the dog,each set of the recesses being formed in conformity with the number and the pitch of holes punched in a sheet 82. When the dog 81 is rotated by rotating a knob 80, a set of recesses formed in correspondence to the number and the pitch of the holes to be punched can be selected.

Each recess is formed in a concave shape having a predetermined length set in consideration of an inertial movement of the head 71 to be moved. When a not shown limit switch attached to the side plate 76 of the head 71 is engaged with a recess, the limit switch is turned on and stops the rotation of the screw rod 73, the spline shaft 72 is rotated once and moves the hole punch vertically, thereby the sheet 82 can be punched. Next, the screwrod 73 is rotated and moves the head 71 one pitch between holes, and the spline shaft 72 is rotated at a position to which the head 71 is moved one pitch, thereby the sheet 82 can be punched.

The electric punch apparatus disclosed in JP-A No.6-55499 is disadvantageous in that it has a large weight because the punch drive motor for moving the punch vertically is mounted on the punch unit 63 and thus a large amount of inertia force is generated when the punch unit 63 moves and stops. Accordingly, when the punch unit 63 is moved by a belt, it is difficult to stop the punch unit having the large amount of inertia force at a proper position and to execute a punch operation accurately. Moreover, a problem also arises in a punch efficiency because the punch unit 63 cannot be moved at a high speed due to its large amount of inertia force.

Further, a corresponding punch position setting guide 65 must be selected from previously prepared punch position setting guides in accordance with the number of holes and the pitch between the holes to be punched in a sheet and the selected punch position setting guide must be set below the reflection type optical sensor provided at the punch unit 63. Since a job for setting the punch position setting guide 65 is troublesome, this is disadvantageous in workability as business equipment.

The multifunction punch apparatus disclosed in JP-A No. 8-206996 has been invented to solve the problems of the electric punch apparatus disclosed in JP-A No. 6-55499. The multifunction punch apparatus is composed such that the rotation of the spline shaft is used as a drive source for driving the vertical movement of the hole punch in place of disposing a drive source for driving the vertical movement of the hole punch in the head. Moreover, since the movement position of the head 71 is controlled mechanically using the dog 81 and the limit switch in the multifunction punch apparatus, no control system is necessary as compared with a case that the movement position of the head 71 is controlled by a computer using, for example, a step motor and with a case that it is controlled by counting pulses using infrared rays, and further a less expensive motor can be used. Accordingly, the multifunction punch apparatus is advantageous in cost reduction.

Incidentally, in the electric punch apparatus and the multifunction punch apparatus disclosed in the respective publications, filing holes can be formed in a sheet in a desired number of holes and a pitch between the holes corresponding to the number of the holes. However, it is necessary to previously prepare the punch position setting guide and the dog to control the positions of the punch unit including the hole punch and the head. Further, an allowable range is set to the longitudinal size and the lateral size of a sheet in the standards of a sheet size prescribed by JIS. Accordingly, even the sheets of the same size have a dimensional error in a longitudinal length and a lateral length when they are contained in a different bundle.

Accordingly, although no particular problem arises when the same type of sheets of the same manufacturer are used at all times, when sheets of different manufacturers are punched with the electric punch apparatus and the multifunction punch apparatus described above, there is a possibility that the sheets are punched with the margins thereof different on a right side and a left side.

At the time, to dispose the margins uniformly on the right side and the left side, the right and left positions of the sheets must be minutely adjusted or the position of the punch position setting guide or the position of the recesses of the dog must be minutely adjusted. Further, a trial punch must be executed again even after the minute adjustment is executed to confirm whether or not the right and left margins are uniformly formed. Moreover, when it cannot be confirmed that the right and left margins are uniformly formed by the minute adjustment executed once, a minute adjustment job and a trial punch job must be repeated until it can be confirmed.

Accordingly, an object of the present invention is to provide a multifunction punch apparatus that can arbitrarily set a sheet size and the number of punch holes and moreover can form accurate punch holes in a sheet.

### SUMMARY OF THE INVENTION

A basic feature of the present invention is a multifunction punch apparatus for punching holes in a sheet, the apparatus comprising a head having a hole punch, a spline shaft passing through the head, vertical movement means for moving the hole punch vertically by a rotation of the spline shaft, movement means for intermittently moving the head according to a punch hole pitch, a punch hole position reference surface for regulating a one-side reference position of a sheet to be punched, control means for controlling a movement position of the head moved by the movement means and a rotation of the spline shaft, and input means for inputting a size of a sheet to be punched, an insert direction of the sheet, a punch hole number, and a correction value for minutely adjusting a punched position of a first punch hole punched by the hole punch with respect to the referenced member, wherein, the control means controls the movement position of the head and the rotation of the spline shaft based on an input value input from the input means.

Further, in the present invention, the hole punch is detachably mounted on the head, and the control means sets the punch hole pitch based on the input information of a type of the hole punch mounted on the head. It is also possible to input the type of the hole punch mounted on the head, that is, information such as the shape, the dimension, and the like of the hole punch from input means. Further, a sensor which detects the type of the hole punch may be provided on the hole punch mounting surface of the head so that the type of the hole punch can be automatically detected when the hole punch is mounted on the head.

In the present invention, a punch hole position reference surface that regulates a one-side reference position of a sheet to be punched is used as a reference position for controlling the movement of the head provided with the hole punch, and the movement position of the head moved by the moving means and the rotation of a spline shaft that moves the hole punch vertically are controlled by control means. Moreover, the above control can be executed by the control means based on the size of a sheet, the insert direction of the sheet, the number of punch holes, and a correction value for minutely adjusting the punch position of a first punch hole punched by the hole punch with respect to the punch hole position reference surface input to the control means.

With the above operation, the punch position of the first punch hole punched with the hole punch can be arbitrarily controlled. Accordingly, even if the right and left margins of the punched sheet are not made uniform when the sheet is punched by setting the size of the sheet, the insert detection range of the sheet, and the number of punch holes, the right and left margins of the punched sheet can be uniformly balanced by executing the correction for minutely adjusting the punch position of the first punch hole.

Moreover, since the head can be moved and controlled in response to a control command from the control means, the positioning accuracy of the head can be enhanced, thereby punching can be executed accurately. An accurate positioning mechanism of the head can be composed by using a control motor such as a step motor as the movement means.

Further, in the present invention, it is preferable that the movement means comprises a control motor and a timing belt which is disposed along the moving direction of the head and whose travel is controlled by the control motor and that the head be mounted on the timing belt.

Further, in the present invention, the movement means may comprise a linear motor, and a slider unit, which includes coils, of the linear motor may be mounted on the head, or the movement means may comprise a shaft motor and and a slider unit, which includes coils, of the shaft motor may be mounted on the head.

As the accurate positioning mechanism, the head may be mounted on a timing belt whose travel is controlled by the control motor as described above, and the head may be moved together with the travel of the timing belt. Otherwise, the accurate positioning mechanism may be composed using a ball screw mechanism or a screw drive mechanism. In this case, a ball screw shaft or a screw shaft is driven by the control motor, and a nut unit, which is screwed on the ball screw shaft or the screw shaft is attached to the head.

Further, the accurate positioning mechanism may be composed using the linear motor or the shaft motor. In this case, a slider unit, which includes coils, of the linear motor or the shaft motor is attached to the head.

The control means may calculate the pitch between punch holes according to the information of the type of a hole punch mounted on the head as well as may automatically set the pitch between the punch holes by previously storing the pitch between the punch holes corresponding to each of the types of hole punches in a memory, and the like and reading out the data therefrom. Further, the control means may form a desired number of filing holes in a sheet by calculating a distance which is to be set between the punch hole position reference surface and the position of a first punch hole punched by the hole punch based on the input information of the size of a sheet to be punched, the insert direction of the sheet, and the number of punch holes and by moving the head at a predetermined distance from the position of the first punch hole at each pitch between holes.

For example, when the right and left margins of a sheet is dispersed in an initial trial punch, it is possible to input a correction value for minutely adjusting the position of the first punch hole to the control means using the input means. With the above operation, the position of the first punch hole can be corrected such that the lengths of the right and left margins of the sheet can be balanced uniformly, thereby filing holes having a good appearance can be formed.

The correction value for minutely adjusting the position of the first punch hole can be determined as described below. That is, when, for example, the first punch hole is to be located at a position spaced apart from the left end of a sheet by a predetermined margin length, the margin length of the right end of the sheet in which dispersion occurs is input and the value half the sum of the margin length of the left end of the sheet and the margin length of the right end is calculated, and the calculated half value may be set as a new margin length of the left end of the sheet. Otherwise, the margin length of the left end of the sheet initially set by the control means may be decreased or increased, and a resultant margin length may be set as a new margin length of the left end of the sheet. With the above operation, the position of the first punch hole can be minutely adjusted simply only by inputting the correction value, thereby a punched sheet can be formed with the right and left margins thereof balanced.

### BRIEF DESCRIPTION OF THE DRAWINGS

FIG. 1 is a perspective view showing an outer appearance of an overall multifunction punch apparatus according to an embodiment of the present invention;

FIG. 2 is a schematic perspective view showing a main portion of a drive mechanism of the apparatus;

FIG. 3 is a partial front elevational view of a punch unit of the apparatus;

FIG. 4 is a left side elevational view of the punch unit shown in FIG. 3;

FIG. 5 is a perspective view of a main portion of the drive mechanism;

FIG. 6 is a plan view showing an example of a layout of a manipulation panel of the apparatus;

FIG. 7 is a plan view showing an example of another layout of the manipulation panel;

FIG. 8 is an explanatory view of a shaft motor;

FIG. 9 is a perspective view showing an outer appearance of an conventional example; and

FIG. 10 is a perspective view showing an outer appearance of another conventional example.

### DESCRIPTION OF THE PREFERRED EMBODIMENTS

A preferable embodiment of the present invention will be explained specifically based on an illustrated example.

The present invention can be applied to a multifunction punch apparatus in which a drive source for driving a head and a drive source for driving a hole punch are mounted neither on the head itself nor on a hole punch section itself. The present invention is by no means limited to the embodiment described below and can be variously modified.

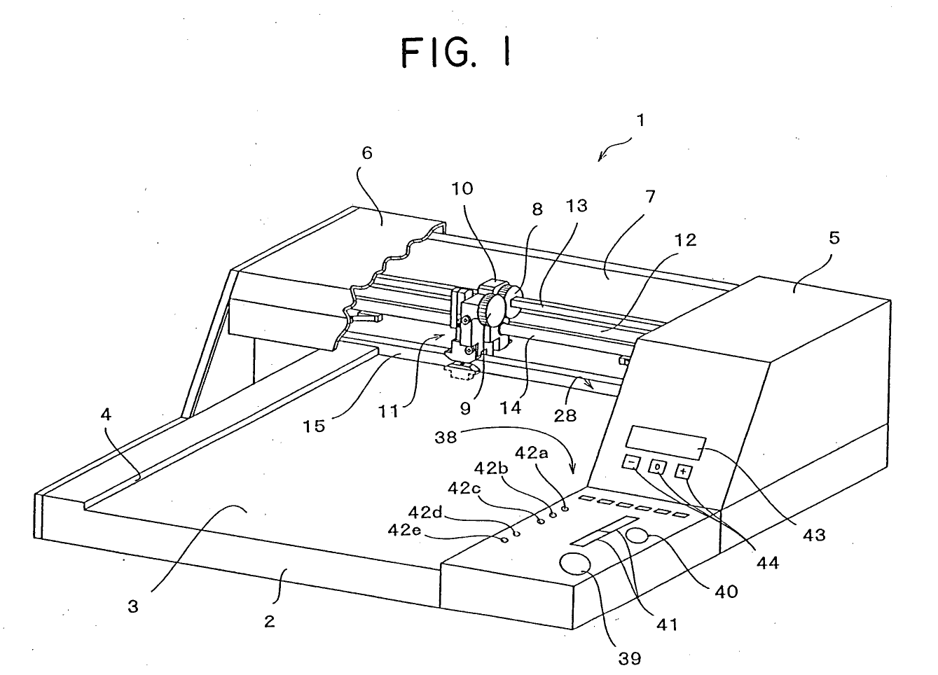

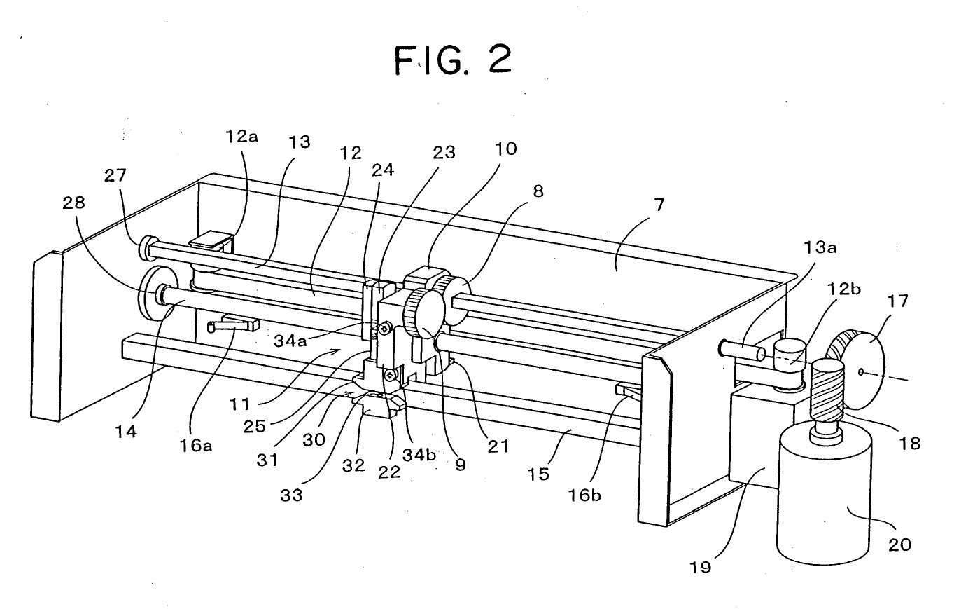

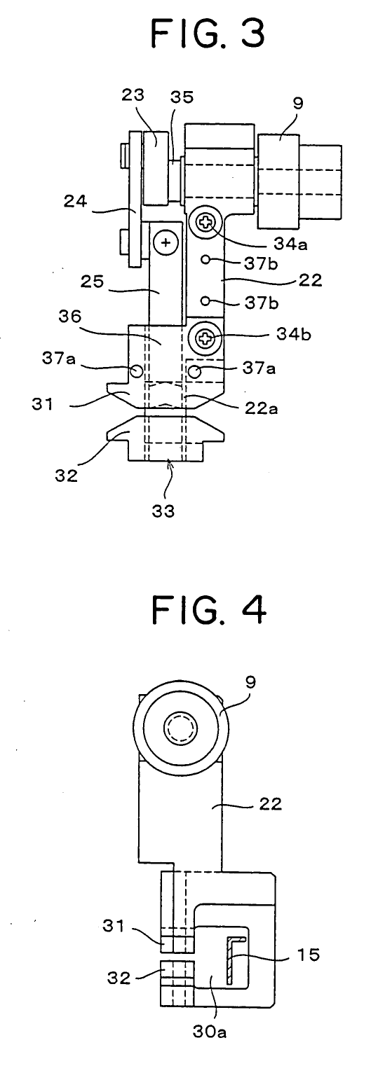

FIG. 1 is a perspective view showing the embodiment in its entirety, and FIG. 2 is a schematic perspective view showing a main portion of a drive mechanism which moves a head 10 and actuates a hole punch 36 (refer to FIG. 3). A frame 7, on which the drive mechanism that moves the head 10 and drives the hole punch 36 shown in FIG. 3 are held, is mounted on a base 2, and the drive mechanism unit and the drive source are covered with an openable and closable opening/closing cover 6 and an manipulation panel cover 5, respectively.

The opening/closing cover 6 is coupled with the base 2 through a hinge, the drive mechanism, which moves the head 10 and actuates the hole punch 36 shown in FIG. 3, is released by turning the opening/closing cover 6 clockwise in FIG. 1, thereby the maintenance, inspection, and the like of the drive mechanism can be executed. The opening/closing cover 6 may be coupled with the frame 7 through the hinge in place of that it is coupled with the base 2 through the hinge. Further, an interval is formed between the lower end of the opening/closing cover 6 and a sheet placing surface 3 of the base 2 so that a predetermined number of sheets can be inserted therebetween.

A punch hole position reference surface 4 is formed of a step portion at the right end of the base 2. Although the punch hole position reference surface 4 is formed on the left side in FIG. 1 in the illustrated example, it may be formed on the right side of the base 2 where a manipulation panel 38 is disposed. Otherwise, a sheet may be positioned at a center using mobile sheet width regulating members, and the like, which are free to approach to and separate from each other. Note that how the punch hole position reference surface 4 is used will be explained later.

Drive sources such as a control motor 19, a drive motor 20, and the like shown in FIG. 2 and a not shown controller that controls the control motor 19 and the drive motor 20 are accommodated in the manipulation panel cover 5. Further, the manipulation panel 38 through which manipulation data is input to the controller is disposed on a surface portion of the manipulation panel cover 5. The manipulation panel cover 5 is attached to the base 2 and the frame 7 through appropriate attachment means, and the maintenance, inspection and the like of the drive sources such as the control motor 19, the drive motor 20, and the like, the controller, and the like can be executed by removing the manipulation panel cover 5.

As shown in FIG. 2, a spline shaft 13 and a slide shaft 14 are disposed in parallel with each other passing through the head 10. Further, the head 10 is fixed to a timing belt 12 which travels under the control of the control motor 19, so as to compose the movement means of the head 10. When the timing belt 12 travels, the head 10 is guided by the slide shaft 14, thereby the movement position of the head 10 is controlled. The timing belt 12 is stretched between a tension bracket 12a and a pulley 12b, and the traveling thereof is controlled by driving the control motor 19 disposed coaxially with the pulley 12b. A step motor can be used as the control motor 19.

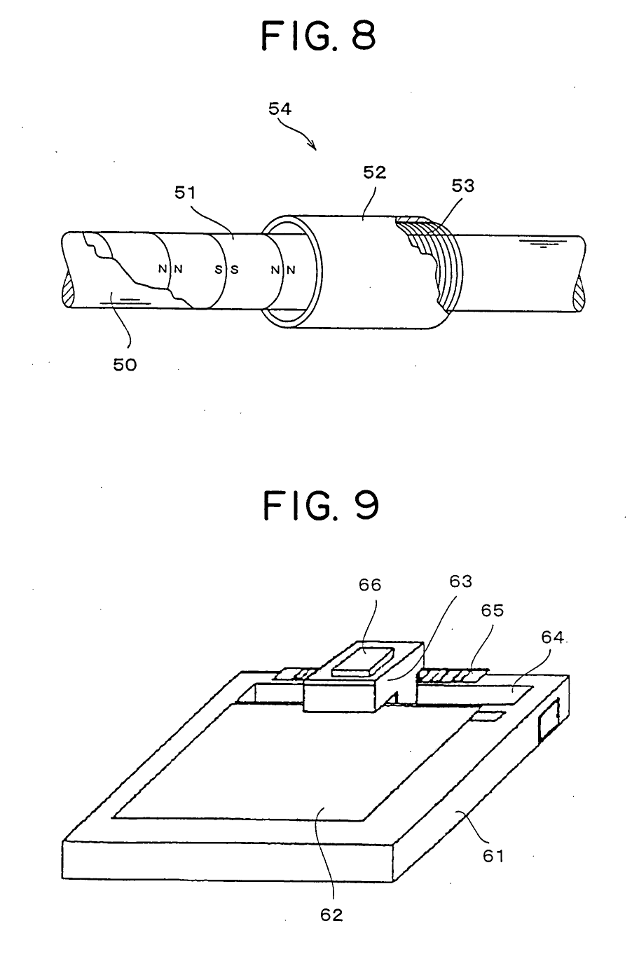

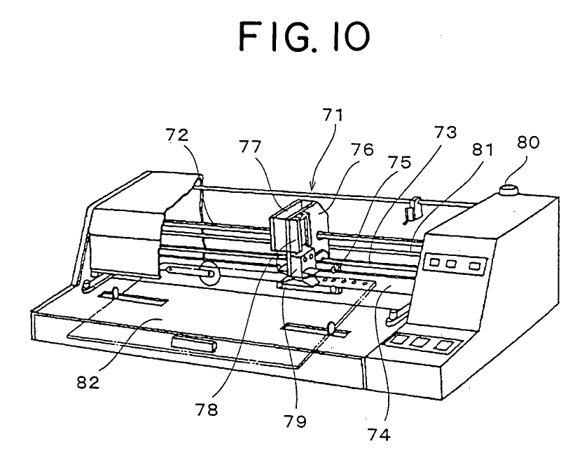

The head 10 may be moved without using the timing belt 12. In this case, as the movement means of the head 10, the slide shaft 14 is composed of a screw shaft, a female screw portion into which the screw shaft is screwed, is formed to the head 10, and the head 10 is moved and controlled with rotating the screw shaft by the control motor. At this time, the screw shaft may be composed of a ball screw, and the female screw portion may be composed of a ball nut. Otherwise, the slide shaft 14 may be composed of a slide shaft of a linear motor, and a slider, which slides on the slide shaft of the linear motor, maybe provided at the head 10. Further, a shaft 50 of a shaft motor 54 may be disposed in placed of the slide shaft 14 as exemplified in FIG. 8. At the time, a slider 52, which is disposed to the shaft 50 in a non-contact state, may be provided at the shaft 50.

As shown in FIG. 8, the shaft motor 54 is basically composed such that cylindrical or polygonal magnets 51 are disposed like a rod so that the intimate contact ends thereof have the same pole, the rod-like magnets 51 are inserted into a cylindrical shaft 50 formed of a non-magnetic material such as stainless steel and the like, and the slider 52 is fitted on the outer peripheral surface of the cylindrical shaft 50 without being in contact there with. The slider 52 is provided with a plurality of sets of three-phase coils 53, and the slider 52 can be moved to and located at a desired position by flowing a three-phase current to the respective coils.

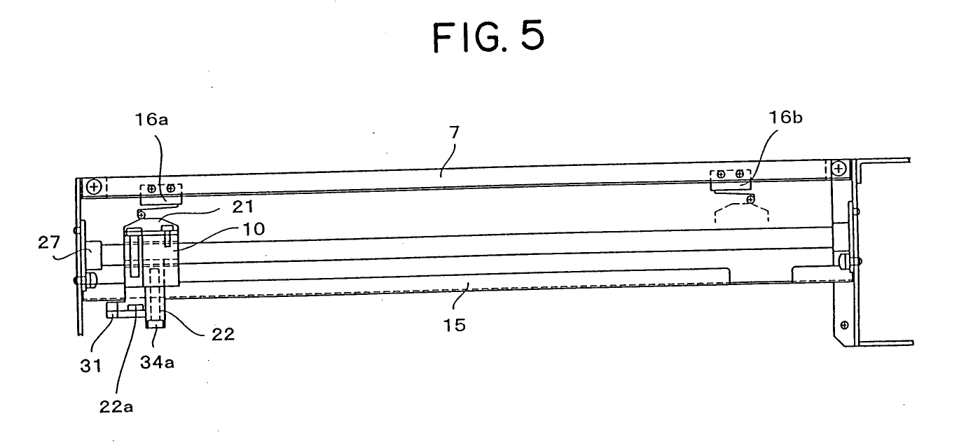

Although the spline shaft 13 in the embodiment is formed in a square columnar shape as shown in FIG. 2, a round bar on which splines are formed may be used as the spline shaft 13. A sheet abutment plate 15 regulates the extreme end position of a sheet to be punched and is disposed in parallel with the spline shaft 13, the slide shaft 14, and the like. Further, as shown in FIG. 5, the sheet abutment plate 15 is inserted into a groove portion 30a formed between a punch guide unit 31 and a guide member 32 of a hole punch section 30.

As shown in FIG. 2, a gear 8 is rotatably supported by the head 10. The gear 8 has a square hole, through which the spline shaft 13 passes, and is disposed such that it can be moved in the axial direction of the spline shaft 13 together with the head 10 and cannot be rotated with reference to the spline shaft 13. The spline shaft 13 is supported to the frame 7 through a bearing 27, and a worm gear 17 is mounted on an end 13a of the spline shaft 13. The worm gear 17 is engaged with a worm wheel 18 journaled by the drive motor 20, and the rotation of the drive motor 20 is transmitted to the gear 8 through the spline shaft 13.

The gear 8 is engaged with a punch drive gear 9 supported by a punch main body 22 of a punch unit 11. The punch main body 22 can be positioned by a pin 37b and detachably attached to the head 10 through a bolt 34a. The type of the punch unit 11 mounted on the head 10 can be detected by a sensor disposed on an abutment surface on which the punch main body 22 is abutted against the head 10.

The sensor can be composed, for example, such that a plurality of contact terminals, which are separated from each other in a non-contact state, are disposed on the abutment surface of the head 10 in a matrix state, and a contact terminal, which forms a different connection turn for coupling the plurality of contact terminals for each of the types of respective punch units 11, is formed on the abutment surface on which the punch main body 22 is abutted against the head 10. With the above feature, a different connection pattern can be detected between the plurality of contact terminals in the head 10 according to the connection pattern of a punch main body 22 mounted on the head 10 in abutment therewith, thereby the type of the punch unit 11 mounted on the head 10 can be automatically detected.

As shown in FIGS. 3 and 4, the punch drive gear 9 supported to the punch main body 22 is attached to an end of a drive shaft 35 supported to the punch main body 22, and eccentrically rotates an eccentric link 23 attached to the other end of the drive shaft 35. An end of a link 24 is pivotally supported by the eccentric link 23, and a sliding element 25 is pivotally supported by the other end of the link 24. When the link 24 is rotated, the sliding element 25 is slid in a vertical direction in FIG. 3 while being regulated by a guide groove 22a formed to the punch main body 22.

A hole punch 36 is attached to the extreme end of the sliding element 25 and can be inserted into a punch hole 33 formed in a guide member 32 by the vertical movement of the sliding element 25. With the above operation, one punch hole can be formed in a not shown sheet inserted between the punch guide unit 31 and the guide member 32. As shown in FIG. 4, the extreme end position of the not shown sheet inserted between the punch guide unit 31 and the guide member 32 can be positioned by the sheet abutment plate 15.

As shown in FIG. 3, the punch guide unit 31 can be positioned to the punch main body 22 by a pin 37a and can be attached thereto by a bolt 34b. When the punch guide unit 31 is removed from the punch main body 22 and the bolt 34a by which the punch unit 11 is attached to the head 10 is removed, the punch unit 11 inserted into the sheet abutment plate 15 can be removed therefrom and the punch unit 11 can be dismounted from the head 10.

Slant surfaces are formed on the side end portions of the punch guide unit 31 and the guide member 32 so that the sheet can be smoothly inserted between the punch guide unit 31 and the guide member 32, and moreover the punch guide unit 31 and the guide member 32 have guide surfaces so that the head 10 can be smoothly moved along the extreme end edge of the sheet. Further, as shown in FIG. 1, the upper surface of the guide member 32 is made approximately flush with the sheet placing surface 3 on the base 2, and the guide member 32 slides in a slide groove 28 formed at an end of the sheet placing surface 3.

Chips punched by the hole punch 36 can be discharged into the slide groove 28. The chips deposited in the slide groove 28 can be also discharged to the outside by forming a chip sweep port in a portion of the slide groove 28. Otherwise, a step portion may be formed from an end of the sheet placing surface 3 to the base 2 in place of forming the slide groove 28 so that an openable/closable cabinet is formed to the step portion on the rear end side of the base 2, and the chips deposited in the step portion may be swept to the outside by exposing the inside of the step portion to the outside by opening the cabinet so as to clean the inside of the step portion.

As shown in FIGS. 2 and 5, limit switches 16a and 16b are disposed at the moving ends of the head 10 and can restrict the moving range of the head 10 by coming into contact with a dog 21 attached to the head 10. The limit switches 16a and 16b are preferably disposed at positions whose interval correspond to the maximum width of a sheet that can be placed on the base 2 or disposed at positions whose interval is somewhat larger than the maximum width thereof. When the limit switches 16a and 16b are actuated so as to stop the driving of the control motor 19, they can act as safety devices that prevent the overrun and the like of the head 10.

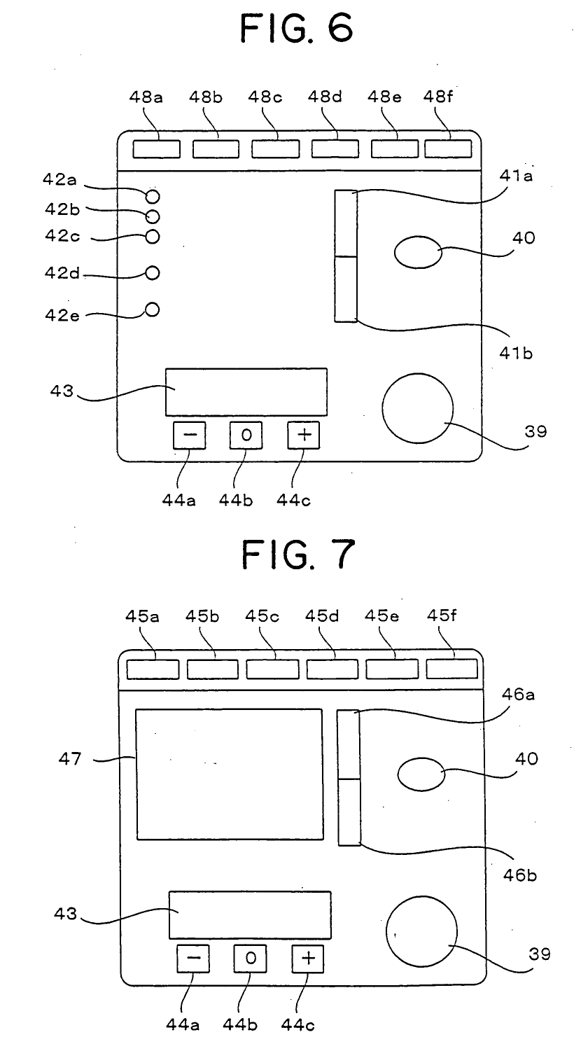

FIG. 6 shows the manipulation panel 38 through which the size of a sheet to be punched, a sheet insert direction, the number of punch holes, and a correction value for correcting the position of a first punch hole to be punched by the hole punch 36 are input. Disposed on the manipulation panel 38 are a start button 39, a selection button 40, sheet size selection buttons 41a and 41b that select A4 size and letter size (LT size), display lamps 42a to 42e, a left margin display unit 43, and increase/decrease switches 44a to 44c. The display lamps 42a to 42e show the insert direction of a sheet selected by the selection button 40, that is, the type of the side of the sheet in which a punch hole is formed and the number of punch holes punched along respective sides, the left margin display unit 43 shows the length from the punch hole position reference surface 4 to the position of the first punch hole, and the increase/decrease switches 44a to 44c correct the length of a left margin displayed in the left margin display unit 43, that is the length from the punch hole position reference surface 4 to the position of the first punch hole.

In the layout of the respective manipulation buttons and the like of the manipulation panel 38 shown in FIG. 6, the positions of the left margin display unit 43 and the increase/decrease switches 44a to 44c are somewhat different from those shown in FIG. 1. However, the same input manipulations as those on the manipulation panel 38 shown in FIG. 6 can be executed also in the manipulation panel 38 shown in FIG. 1. Next, a control method of executing a punch operation using the manipulation panel 38 shown in FIG. 6 will be explained.

Whether the size of a sheet to be punched is A4 size or LT size is selected by selecting the sheet size selection buttons 41a or 41b. Only two kinds of sheet sizes, that is, A4 size and LT size can be selected in the manipulation panel 38 shown in FIG. 6. However, since the respective sizes of A series, the respective sizes of B series, Legal size, and the like are ordinarily used in addition to A4 size and LT size, the sheet size selection buttons as many as the necessary kinds of sheets may be disposed so that a plurality of sheets having respective sizes can be selected.

When A4 size is selected by pressing the sheet size selection button 41a, it is selected by the selection button 40 to punch 20 holes along a long side, 14 holes along a short side, or 21 holes along the long side. When the selection button 40 is pressed, the display lamp 42a for 20 holes along the long side is put on, when it is pressed once more, the display lamp 42a is put out and the display lamp 42b for 14 holes along the short side is put on. When the selection button 40 is pressed again, the display lamp 42b is put out and the display lamp 42c for 21 holes along the long side is put on. When the selection button 40 is further pressed, the display lamp 42c is put out, and the display lamp 42a is put on. As described above, the number of holes to be punched along a side can be selected by the number of times of depression of the selection button 40, and the condition of the number of selected holes can be confirmed depending on any one of the display lamps 42a to 42c is put on.

When the LT size is selected by selecting the sheet size selection button 41b, 19 holes along a long side or 15 holes along a short side can be selected by pressing the selection button 40. Further, a sheet to be punched, which is selected by the sheet size selection buttons 41a and 41b and the selection button 40, is positioned by abutting the left edge of the sheet against the punch hole position reference surface 4 shown in FIG. 1, inserting the extreme end of the sheet between the punch guide unit 31 and the guide member 32, and abutting the extreme end edge of the inserted sheet against the sheet abutment plate 15. When any one of a plurality of punch units 11 is selectively mounted on the head 10 according to the shape of a hole to be punched, the type of the punch unit 11 mounted on the head 10 can be input by punch unit selection switches 48a to 48f. Otherwise, the type of a punch unit 11 mounted on the head 10 can be also automatically detected from a detection value detected using the above-described sensor, and the like provided with the head 10.

When the size of the sheet positioned and placed on the sheet placing surface and the number of holes to be punched along the long or short side of the sheet are set as described above, the start button 39 is turned on. When the not shown controller receives the on-signal of the start button 39, the information set through the sheet size selection buttons 41a and 41b and the selection button 40 is input to the controller.

When any one of the plurality of punch units 11 is selectively mounted on the head 10 according to the shape of the hole to be punched, the controller determines whether or not the number of holes set along a long or a short side can be punched in a selected sheet size by the punch unit 11 mounted on the head 10. When the controller determines that the holes cannot be punched to the desired sheet by the punch unit 11, it may be displayed in the left margin display unit 43, or the like that the combination of the sheet and the punch unit is abnormal. Further, for example, the type of a punch unit 11 corresponding to the set sheet may be displayed in the left margin display unit 43, or the like.

When an optimum combination of the sheet and the punch unit 11 is selected, the controller moves the head 10 to a preset first punch position spaced apart from the punch hole position reference surface 4 by the length of a left margin by driving and controlling the control motor 19, the first punch position being a position set based on the information input to the controller. After the control motor 19 is stopped, the spline shaft 13 is rotated a predetermined number of revolutions by driving the drive motor 20. As shown in FIGS. 1 and 2, the punch drive gear 9 is rotated once through the gear 8 by rotating the spline shaft 13 the predetermined number of revolutions. As shown in FIGS. 3 and 4, the sliding element 25 is moved vertically through the eccentric link 23 and the link 24 by rotating the punch drive gear 9 once, thereby a punch hole having a shape of the hole punch 36 can be punched in the sheet inserted between the punch guide unit 31 and the guide member 32 with the hole punch 36 attached to the lower end of the sliding element 25.

When the punch hole is punched in the sheet with the hole punch 36, the control motor 19 is driven and controlled so that the head 10 moves by a pitch between adjacent holes corresponding to the number of set holes. When the head 10 is positioned at the position of a next hole, the driving of the control motor 19 is stopped, and the hole punch 36 is actuated by driving the drive motor 20. The set number of holes are punched in the sheet by sequentially repeating the movement and positioning of the head 10 and the actuation of the hole punch 36.

When the head 10 is excessively moved rightward in FIG. 2 because the position of the first punch hole is offset, and the like, the limit switch 16b turns on by the dog 21 disposed to the head 10, thereby the driving of the control motor 19 can be stopped. With this operation, the head 10 can be prevented from being abutted against the frame 7 and the control motor 19 can be prevented from losing synchronization.

Reversely, even if the head 10 overruns leftward in FIG. 2, the abnormal movement of the head 10 is detected by the limit switch 16a, and the driving of the control motor 19 can be also stopped. The limit switch 16a may be also used as a position sensor which prescribes the position of the head 10 corresponding to the punch hole position reference surface 4 in FIG. 1.

When right and left margins are not uniformly formed in a punched sheet, the length of the left margin can be adjusted by manipulating the increase/decrease switch 44a or 44c. As an adjustment method, the right and left margins of the sheet can be adjusted uniformly by displaying a standard margin length corresponding to the number of set holes in the left margin display unit 43 and increasing or decreasing the standard margin length displayed in the left margin display unit 43 by pressing the increase/decrease switches 44a or 44c. Otherwise, the right margin length of a punched sheet is input to the controller, and an average value is determined by the controller from a standard left margin length and the right margin length input to the controller, thereby the average value may be set again as the left margin length. As described above, first, a sheet may be punched as a trial to confirm the balance of the right and left margins which may be then corrected so that they are balanced.

Although it is explained in the embodiment to execute punching using the left side of a sheet as a reference, it is also possible to execute punching using the right side of the sheet as the reference. Further, it is also possible to set the position of a sheet by centering it based on the center position of the sheet placing surface 3 using a movable sheet edge jogging plate, and the like. Since the first punch hole position can be simply set and the the right and left margin lengths can be simply adjusted by setting the position of a sheet using its one side as a reference, it is preferable to set the position of the sheet based on the one-side reference.

When a sheet is placed on the sheet placing surface 3 and the start button 39 is turned on after the left margin of the sheet is adjusted by executing trial punching, punch holes can be formed in the sheet with the right and left margins thereof set uniformly. When the right and left margins of the sheet are balanced once, it is possible to punch holes in sheets in the state that the right and left margins thereof are balanced without correcting the left margin of the sheets in the bundles of the same sheets punched thereafter.

FIG. 7 shows another modification of the manipulation panel 38. The basic featuret of the manipulation panel 38 in FIG. 7 is the same as the manipulation panel 38 shown in FIG. 6 except the contents displayed on the manipulation panel 38. That is, different contents are displayed thereon because the manipulation panel 38 is provided with sheet selection buttons 45a to 45f that can select A4 size, A5 size, B4 size, B5 size, LT size, and Legal size. Further, the modified manipulation panel 38 is additionally provided with sheet length direction buttons 46a and 46b through which it is selected whether holes are punched along the long side of a sheet or along the short side thereof.

When, for example, A4 is selected by the sheet selection button 45a and punching along the long side direction of a sheet is selected by the sheet length direction button 46a, a display unit 47 displays the numbers of punch holes that can be punched by the hole punch 36 mounted on the head 10. One of the displayed numbers of punch holes can be selected by the selection button 40. Otherwise, the number of punch holes can be selected by composing a display screen of the display unit 47 of a touch panel.

Since the functions of the margin display unit 43 and the increase/decrease switches 44a to 44c are the same as those in FIG. 6, the explanation thereof is omitted. Increasing the size of the screen of the display unit 47 makes it possible to display the contents, which are displayed on the margin display unit 43, on the display unit 47 having the increased screen size. Further, all the data such as a sheet size, selection of a side along which holes are punched, the number of punch holes, a left margin length, adjustment of the left margin length, and the like can be input through the touch panel on the display unit. As described above, the feature of the manipulation panel 38 can be variously modified.

1. A multifunction punch apparatus for punching holes in a sheet, comprising: a head having a hole punch; a spline shaft passing through the head; vertical movement means for moving the hole punch vertically by a rotation of the spline shaft; movement means for intermittently moving the head according to a punch hole pitch; a punch hole position reference surface for regulating a one-side reference position of a sheet to be punched; control means for controlling a movement position of the head moved by the movement means and a rotation of the spline shaft; and input means for inputting a size of the sheet to be punched, an insert direction of the sheet, a punch hole number, and a correction value for minutely adjusting a punched position of a first punch hole punched by the hole punch with respect to the punch hole position reference surface,
wherein the control means controls the movement position of the head and the rotation of the spline shaft based on an input value input from the input means.

2. A multifunction punch apparatus according to claim 1, wherein the hole punch is detachably mounted on the head, and the control means sets the punch hole pitch based on input information of a type of the hole punch mounted on the head.

3. A multifunction punch apparatus according to claim 1 or 2, wherein the movement means comprises a control motor and a timing belt which is disposed along a moving direction the head and whose travel is controlled by the control motor, and wherein the head is mounted on the timing belt.

4. A multifunction punch apparatus according to claim 1 or 2, wherein the movement means comprises a linear motor, and a slider unit, which includes coils, of the linear motor is mounted on the head.

5. A multifunction punch apparatus according to claim 1 or 2, wherein the movement means comprises a shaft motor, and a slider unit, which includes coils, of the shaft motor is mounted on the head.
